(19) United States
(12) Patent Application Publication
(10) Pub. No.: US 2015/0085365 A1
(43) Pub. Date: Mar. 26, 2015

(54) LOW BIREFRINGENT SENSOR SUBSTRATE AND METHODS THEREOF

(71) Applicant: Corning Incorporated, Corning, NY (US)

(72) Inventors: John Claude Cadotte, JR., Waterboro, ME (US); John Stephen Peanasky, Big Flats, NY (US); Christopher Lee Timmons, Big Flats, NY (US); Srinivasa Rao Vaddiraju, Painted Post, NY (US); Nikhil Baburam Vasudeo, Pune (IN); Tyler Wezner, Riverside, RI (US)

(73) Assignee: Corning Incorporated, Corning, NY (US)

(21) Appl. No.: 14/386,583

(22) PCT Filed: Mar. 26, 2013
(86) PCT No.: PCT/US13/33808

§ 371 Date: Sep. 19, 2014

Related U.S. Application Data
(60) Provisional application No. 61/616,089, filed on Mar. 27, 2012.

(51) Int. Cl. G02B 5/18

(52) U.S. Cl. CPC G02B 5/1852; G02B 5/18
USPC 359/569; 264/1.24

(57) ABSTRACT

A resonant waveguide article, including: a polymeric substrate having at least one integral grating region, wherein the article has a low birefringence property of for example, from about 5 to 270 nm/cm, as defined herein. Also disclosed is a microplate including the resonant waveguide article, and an integral well plate bonded to the sensor article, as defined herein. Also disclosed are methods of making a sensor article, and a method of making and using the microplate including the sensor article, as defined herein.

### CROSS-REFERENCE TO RELATED APPLICATIONS

This application claims the benefit of priority under 35 U.S.C. §119 of U.S. Provisional Application Ser. No. 61/616,089, filed Mar. 27, 2012, the content of which is relied upon and incorporated herein by reference in its entirety.

This application is related to commonly owned and assigned U.S. Provisional Patent Application Ser. No. 61/616,085, entitled “MICRO-FEATURE METHODS FOR OVER-MOLDING A SUBSTRATE,” filed Mar. 27, 2012, but does not claim priority thereto.

### FIELD

The disclosure relates generally to manufacturing processes for a low birefringent sensor-substrate and methods of use thereof.

### BACKGROUND

Various methods are known for making a substrate having at least one resonant waveguide grating sensor, and methods of use thereof.

### SUMMARY

The disclosure provides a method of making low birefringent sensor-substrate and a well plate including the low birefringent sensor-substrate.

### BRIEF DESCRIPTION OF THE FIGURES

In embodiments of the disclosure:

FIG. 1 shows a conventional method for making a microplate assembly in an exploded view.

FIGS. 2A to 2C show in cross-sections an illustrative over mold process.

FIG. 3 shows a screen shot example output from optical retardation measurements.

FIG. 4 shows a CAD image of how mold tooling (410) can be inserted into or interchanged in the mold (400) for investigating various runner (420) designs.

FIG. 5 shows a consistently oriented birefringence pattern of a comparative center gate substrate rotated through 90 degrees on a polarizer table.

FIG. 6 shows a normalized reflectivity map of the comparative center-gate substrate illustrating the reflectivity depression in opposing quadrants.

FIG. 7 shows a polarizer image of a comparative center-gated substrate having added arrows to indicate the melt flow direction.

FIG. 8 shows quadrant identification for a comparative center-gate substrate.

FIG. 9 shows a measurement of optical retardation (birefringence) as a function of radial distance from the center of the part (gate) along the paths described in FIG. 8.

FIG. 10 shows a comparison of the optical retardation (birefringence) and reflectivity as a function of radial distance from the center of the part (gate) along the paths described in FIG. 8.

FIG. 11 shows an illustration of the effect of birefringence on the reflected power spectrum.

FIG. 12 shows a normalized reflectivity map illustrating the effect of birefringence in the A1 corner due to biaxial flow.

FIGS. 13A to 13C show, respectively, a partial fan gate (13A; left), full fan gate (13B; center), and the inventive deep dish gate (13C; right).

FIGS. 14A to 14C show, respectively, stress states predicted by modeling and the experimentally observed birefringence.

FIGS. 15A and 15B show insets of the molecular orientation at the skin and core for the, respective, partial fan gate (15A; left) and deep dish gate (15B; right).

FIG. 16 shows a change in density of the substrate versus hold time.

FIG. 17 shows experimental results having a decrease in birefringence with increase in hold time.

FIGS. 18A and 18B show top views of a deep dish gate (18A; left) and a fullest deep dish gate (18B; right), and the side view of the gate region (middle).

FIG. 19 shows experimental and modeling results for a fullest deep dish configuration.

FIGS. 20A and 20B show optical polarimeter images of a comparative substrate (20A) and a low birefringent substrate (20B) produced using injection molding with the disclosed tooling and process.

FIG. 21 shows a normalized reflectivity map of a low birefringent substrate.

FIG. 22 shows a schematic of prior art conventional runner.

FIGS. 23A and 23B show, respectively, a runner cross section comparing the prior art sloped fan style (23A; left) and the inventive ‘melt reservoir’ style (23B; right).

FIGS. 24A and 24B show, respectively, modeled pressure profile differences between the conventional sloped fan runner (24A; left) and the melt reservoir runner (24B; right).

### DETAILED DESCRIPTION

Various embodiments of the disclosure will be described in detail with reference to drawings, if any. Reference to various embodiments does not limit the scope of the invention, which is limited only by the scope of the claims. Additionally, any examples set forth in this specification are not limiting and merely set forth some of the many possible embodiments of the claimed invention.

In embodiments, the disclosed articles, and the method of making and use of the articles provide one or more advantageous features or aspects including, for example, as discussed below. Features or aspects recited in any of the claims are generally applicable to all facets of the invention. Any recited single or multiple feature or aspect in any one claim can be combined or permuted with any other recited feature or aspect in any other claim or claims.

### DEFINITIONS

“Birefringence,” “birefringent,” “double refraction,” and like terms refer to the refraction of light in an anisotropic material or medium, such as the substrate having grating regions, in two slightly different directions to form two rays.

“Integral” in the context of the “integral grating region” refers to an integrated or single piece construction arising from the single injection step used to mold the article that simultaneously, or at the same time, produces the polymeric substrate having the at least one integral grating region.

“Integral” in the context of the “integral well plate bonded to the article” refers to an integrated or single piece construction arising from joining the molded article comprising the substrate and grating region with a well plate structure. The joining of the article and the well plate can be accomplished, for example, in an over-mold step, laser welding, adhesive bonding, or like methods.

“Substantially” in the context of the optical axis orientation of the birefringence being substantially parallel or perpendicular refers to being within about 20 degrees or less of parallel or perpendicular to the at least one grating region.

“Parallelism” refers to a relative measure or deviation from parallel between the faces or upper surface and lower surface of the substrate.

“Include,” “includes,” or like terms means encompassing but not limited to, that is, inclusive and not exclusive.

“About” modifying, for example, the quantity of an ingredient in a composition, concentrations, volumes, process temperature, process time, yields, flow rates, pressures, and like values, and ranges thereof, employed in describing the embodiments of the disclosure, refers to variation in the numerical quantity that can occur, for example: through typical measuring and handling procedures used for making compositions, concentrates, or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture. The appended claims include equivalents of these “about” quantities.

“Consisting essentially of” in embodiments refers, for example, to a sensor-substrate article or a well plate article having, for example, predetermined physical properties such as birefringence, to a method of making a sensor-substrate article or a well plate article, and can include the components or steps listed in the claim, plus other components or steps that do not materially affect the basic and novel properties of the compositions, articles, apparatus, or methods of making and use of the disclosure, such as particular reactants, particular additives or ingredients, a particular agents, a particular surface modifier or condition, or like structure, material, or process variable selected. Items that may materially affect the basic properties of the components or steps of the disclosure or that may impart undesirable characteristics to the present disclosure include, for example, an article having significantly higher birefringence, and methods of making having more than a single injection molding step to form the sensor-substrate article that are beyond the values, including intermediate values and ranges, as defined and specified herein.

The indefinite article “a” or “an” and its corresponding definite article “the” as used herein means at least one, or one or more, unless specified otherwise.

Abbreviations, which are well known to one of ordinary skill in the art, may be used (e.g., “h” or “hr” for hour or hours, “g” or “gm” for gram(s), “mL” for milliliters, and “rt” for room temperature, “nm” for nanometers, and like abbreviations).

Specific and preferred values disclosed for components, ingredients, additives, and like aspects, and ranges thereof, are for illustration only; they do not exclude other defined values or other values within defined ranges. The compositions, apparatus, and methods of the disclosure can include any value or any combination of the values, specific values, more specific values, and preferred values described herein.

The Corning, Inc., EPIC® technology is commercially available in several product platforms and can be used to perform label-free biological assays using resonance waveguide sensors in a microplate format. These assays can be performed, for example, on individual protein targets or cells using conventional high throughput screening (HTS) protocols. A resonant waveguide (RWG) sensor is positioned at the bottom of each well to detect refractive index changes, wavelength changes, or like changes at the surface of the sensor. The refractive index shift correlates to a mass change and can be used to detect binding of small molecules to the surface. The sensor can also detect changes in the mass distribution of live cells that reside within the evanescent wave, such as about 150 nm from the surface. This has been shown to correlate to certain cellular responses. An EPIC® reader is used to interrogate the microplates and perform assays.

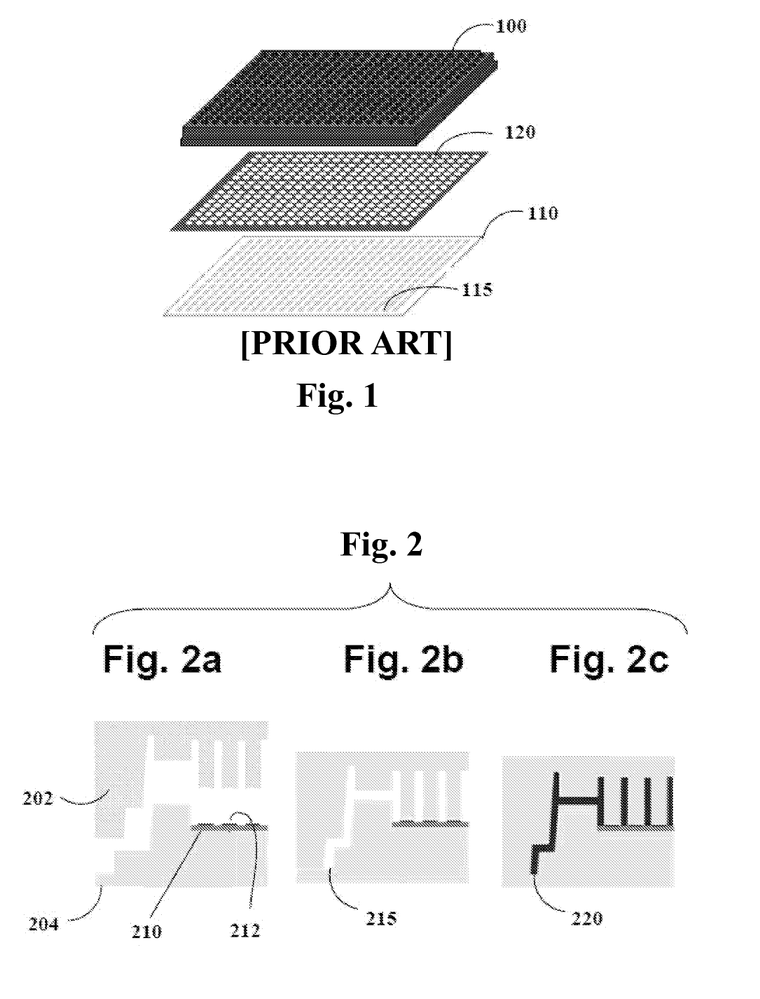

The EPIC® resonant waveguide grating (RWG) sensor can be produced on glass substrates using a process similar to imprint lithography to create nano-scale gratings structures. The grating features are imprinted in a polymer thin film that overlays the glass sheet. This forms the substrate of the sensor. This method results in a two-layer substrate (i.e., plastic on glass) that is more expensive to manufacture since it requires more process steps and significant inspections. Secondly, the thickness uniformity of the polymer can be difficult to control and can reduce the reflected power due to refraction of the beam during interrogation of the sensor. A uniform 150 nm niobium oxide thin film can be deposited over the features completing the sensor manufacture. In accordance with known practices the substrate can be attached to an injection molded microplate body using a pressure sensitive adhesive gasket as shown in FIG. 1 forming an assembled EPIC® microplate. FIG. 1 shows a three-piece microplate assembly in an exploded view, including a well plate (100), a substrate or insert (110) having one or more grating regions (115), and an intermediate adhesive gasket (120).

A homogeneous polymeric substrate provides a number of advantages over the existing manufacture process in terms of reduced cost and design complexity. However, in embodiments, it has been demonstrated that the substrate must have no or low levels of birefringence to obtain uniform reflected power from the sensors. A low cost method of producing such a substrate is injection molding. An injection molded substrate may still call for a high refractive index coating, such as niobium oxide film, for sensor functionality. Injection molding of substrates and features of this size is common, for example, in the CD/DVD disc manufacture industry; however, this substrate and process have distinctly different requirements. Significant differences include, for example, the overall substrate shape and center cut-out, the gate location and dimensions, the sensitivity to birefringence, and the sensitivity to feature dimensions on a nano-scale.

Another advantage of an injection molded substrate is the inherent compatibility with over molding of a body onto the substrate which is also a lower cost and more scalable process that the aforementioned PSA assembly process. The over molding process is shown in FIGS. 2A to 2C. The over mold process uses homogeneous polymeric substrates in conventional implementation. FIG. 2A shows a substrate (210) having one or more integral grating regions (212) on or in the substrate. The substrate is situated in an “open” over-mold comprised of a supporting base mold half (204) and top mold half (202). FIG. 2B shows the substrate is situated in a “closed” over-mold having a cavity (215). FIG. 2C shows the substrate situated in the “closed” over-mold having a cavity (215) of FIG. 2B, which cavity has been filled by injection molding or like processes to provide the over-molded well plate article (220) having the integral substrate when the over-mold (202) and (204) are separated from the well plate article (220).

This is a conventional process for producing microplates where the substrate and body are of like materials. In this process, the substrate or substrate is loaded into the injection mold for the body and the body is molded onto the substrate. This combines the two processes of: injection molding of the body, and assembling the microplate into a single sequence. Because the materials are the same or similar, the hot polymer melt can heat the substrate and a chemical bond can be formed between the substrate and the body by polymer entanglement. For EPIC® substrates, the niobium oxide film can prevent intimate contact between the substrate and the incipient body as a polymer melt, and thereby interfere with polymer entanglement between the bulk substrate and polymer melt. Applicant's above-mentioned commonly owned U.S. Patent Application No. 61/616,085, describes methods to overcome this issue.

A homogeneous polymer substrate having a low birefringence is a significant cost and scalability improvement over existing methods of making RWG sensor substrates, and enables body over-molding methodology. The disclosure describes the characteristics of the substrate and examples for manufacture including: mold tooling design modifications, unconventional process conditions, and functional requirements.

In embodiments, the disclosure provides a homogenous polymeric substrate having low levels, for example, from about 5 to about 270 nm/cm, such as from about 10 to about 250 nm/cm, of intrinsic birefringence. Manufacture of this type of substrate by injection molding involves unconventional tooling designs, process conditions, and an understanding of system interactions. A non-traditional gating and runner design includes a fan gate that spans the entire length of substrate but having a width of only about 30% of the part. The gating land width was also found to be a significant design parameter. Prior to the gate, the runner incorporates a melt ‘reservoir’ to improve the uniformity of the pressure gradient across the mold. In embodiments, the injection molding process of making low bi-refringent parts calls for a longer hold time than typical optical parts, for example, greater than about 4 seconds, and a complex hold pressure profile to reduce liquid resin backflow into the mold.

In embodiments, the disclosure provides significant advantages, including, for example:

low and uniform birefringence within the substrate results in greater uniformity in the power of the reflected light, and thus reduces noise and reduces sensor or instrument alignment requirements (e.g., theta/phi specification);

a homogeneous polymeric substrate having low birefringence that enables production of RWG sensor substrates using a low cost injection molding manufacturing process; and

a homogeneous polymeric substrate having low birefringence enables fabrication of microplates using a low cost injection over molding manufacturing process.

In embodiments, the disclosure provides a resonant waveguide grating article, comprising:

a polymeric substrate, also known as an insert, having at least one integral grating region,

wherein the article has a low birefringence property of from about 5 to 270 nm/cm, from about 10 to 250 nm/cm, including intermediate values and ranges, such as about 250 nm/cm or less, of intrinsic birefringence.

The article can have low levels of intrinsic birefringence, for example, less than about 270 nm/cm, such as from about 1 to about 250 nm/cm, from about 5 to about 225 nm/cm, from about 10 to about 200 nm/cm, including intermediate values and ranges, where the birefringence is normalized to the thickness of the substrate.

In preferred embodiments, the length and width dimensions, i.e., nominal target dimensions, of the substrate can be, for example, 4.7 by 3 inches, the thickness is from 0.5 about 1.5 millimeters having less than about 2% variation (e.g., within a single part across the entire substrate), and the integral grating height is about 0.05 to 1 micrometer.

In embodiments, the substrate is considered thick and is considered rigid, that is, the substrate maintains its dimensional integrity, that is its shape, geometry, flatness, and like metrics after being molded and during subsequent assembly or processing, storage, and while in use in label free imaging assays. The substrate can have, for example, a thickness of from about 250 micrometers to about 2 millimeters, preferably 300 micrometers to about 1.5 millimeters, more preferably 0.5 about 1.5 millimeters, even more preferably 500 micrometers to about 1.25 millimeters, and even more preferably 800 micrometers to about 1.20 millimeters, including intermediate values and ranges.

The substrate and the integral grating region can be composed of, for example, an optically transparent engineering resin. The optically transparent engineering resin can be, for example, a cyclic-olefin polymer (COP) such as a cyclic-olefin copolymer COC resin (Topas Advanced Polymers), a polystyrene resin, or a combination thereof.

The optical axis orientation of the birefringence can be, for example, substantially parallel or perpendicular to the lines of at least one of the grating regions. Such an optical axis orientation of the birefringence tends to result in the least impact to reflectivity.

The article can have high power uniformity where, for example, the power of each of sensor in the article is within about 30% of the maximum power of the sensor.

In embodiments, the article can further comprise, for example, an integral well plate directly bonded to the article to provide a microplate.

In embodiments, the disclosed microplate can have, for example, an optical alignment variation of less than 2 milliradians, flatness and parallelism variation such that the angle between the launch and reflected light beams is less than 2 milliradians for each of the sensors in the microplate.

In embodiments, the microplate can have, for example, from 1 to 1536 wells, or more, such as 6, 24, 96, 384, or 1536 wells or sample compartments or more, and like formats, including intermediate values and ranges. The wells or sample compartments can be open on one side and closed by the bonded substrate (having the integral grating region) on the opposite side. The wells or sample compartments can be, for example, of the same or different capacities, such as 0.1 nanoliter to 1,000 microliters.

In embodiments, the at least one integral grating region can be, for example, a plurality of parallel grating lines.

In embodiments, the disclosure provides a method of making the aforementioned article, comprising:

a single cavity injection molding to form the substrate having at least one grating feature on at least one surface of the substrate,

the mold used for the single cavity injection molding comprises a melt reservoir prior to a gate, the gate being about 30% of the width of the substrate mold cavity, the melt reservoir can be situated in a runner leading to the gate, the melt reservoir enhances the parallelism of the injected resin flow, and the single cavity injection molding can be accomplished at high pack pressure of about 5,000 psi to about 10,000 psi, such as 8,000 psi, for about 0.1 seconds and then a long hold time of, for example, greater than 5 seconds at a lower pressure, for example, from about 2,000 psi to about 4,500 psi, such as about 4,000 psi. The initial resin injection fill (i.e., shoot) time of about 0.1 to 0.5 seconds, and the resulting article has a low birefringence property of from about 5 to 270 nm/cm, including intermediate values and ranges.

In embodiments, the optical axis orientation of the birefringence can be, for example, substantially parallel or perpendicular to the at least one grating region. Typically all gratings are aligned in the same direction. In embodiments, the optical axis orientation of the birefringence can be, for example, substantially parallel to the lines of at least one grating region.

In embodiments, the single injection molding step to form the substrate having at least one grating region on at least one surface of the substrate can be accomplished, for example, with a metal master containing the grating pattern on at least one half of the mold cavity, i.e., a DVD stamp method. Alternative methods, for forming sensor gratings on a surface of the substrate can be accomplished by, for example, hot embossing methods. In embodiments, the finished part can be picked by robotic picker, or like article handling devices.

In embodiments, the method of making can further comprise an assembly step to join the low birefringent substrate article and a well plate to form a unitary (i.e., a one-piece) microplate assembly containing at least one well. Examples of suitable assembly methods include UV adhesive, pressure sensitive adhesive, laser welding, sonic welding or injection over molding and shooting resin to form a one-piece microplate assembly having at least one well.

In embodiments, the disclosure provides a method of making a microplate, the microplate comprising a substrate having an integral grating sensor, and an integral well plate, the method comprising:

a first injection molding to form a substrate having sensor gratings on at least one surface of the substrate; and

a second injection molding comprising placing the resulting low birefringent substrate having sensor gratings in an over-mold and shooting resin to form a unitary one-piece microplate assembly,

wherein the substrate has a low birefringence property of from about 5 to 270 nm/cm.

### EXAMPLES

The following examples serve to more fully describe the manner of using the above-described disclosure, and to further set forth best modes contemplated for carrying out various aspects of the disclosure. These examples do not limit the scope of this disclosure, but rather are presented for illustrative purposes. The working example(s) further describe(s) how to prepare the substrate-sensor grating articles and microplate articles incorporating the substrate-sensor grating articles of the disclosure.

### Materials and Methods

Injection Molding

Injection molding of the substrate can be performed using a commercially available cyclic co-olefin material (Topas 5013L; TOPAS Advanced Polymers, Inc., Florence, Ky.). The substrate mold can be a typical existing design having a core and cavity half with the exception of inventive design modifications described below. The inventive mold uses a side-gate or fan-gate style runner design. The grating pattern can be transferred using a stamper that is placed in one of the halves of the substrate mold. The stamper can be, for example, a 300 micron nickel plate fabricated by electroforming over a polymer master that contains the grating pattern. This approach is analogous to existing DVD fabrication processes. Polymeric substrates having the at least one sensor region can be coated with a niobia waveguide layer following injection molding, such as by chemical vapor deposition, sputtering, and like coating methods, or combinations thereof.

Microplate Characterization Methods

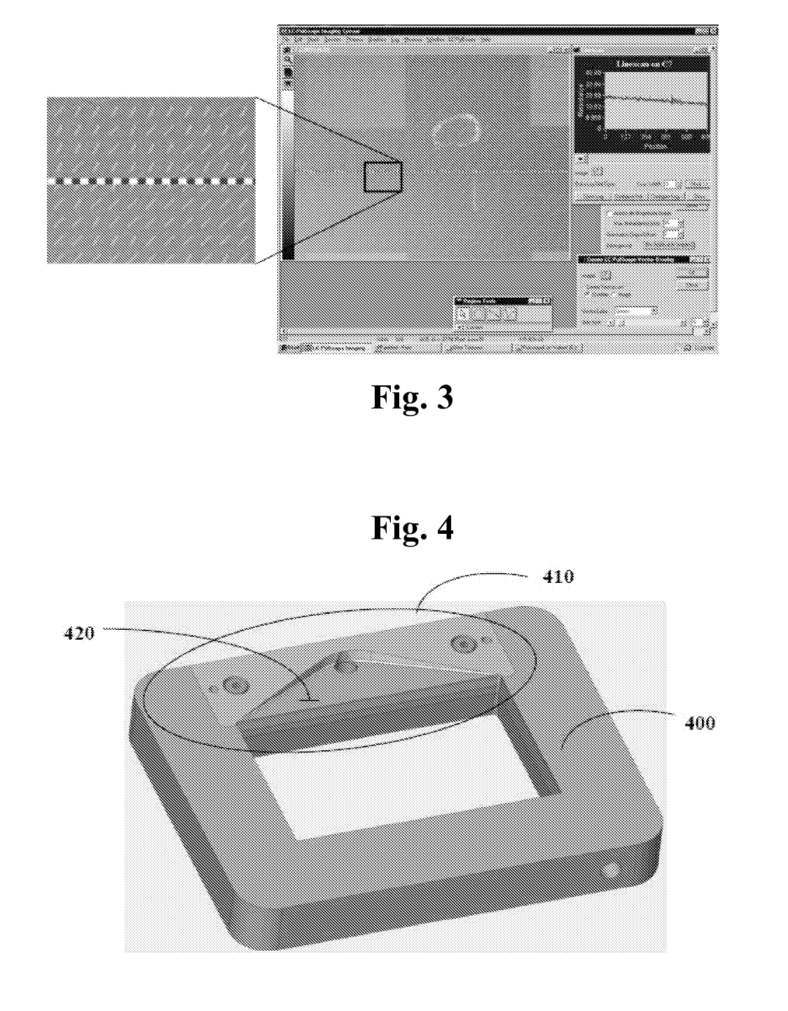

The PolScope is a versatile, simple to use, polarized light microscopy technique which is able to generate two-dimensional maps of optical retardation (stress) for a variety of sample sizes and configurations (see for example, the LC-PolScope™ macro imaging system for quantitative birefringence imaging available from CRi, Hopkinton, Mass.). The technique uses variable retarders in combination with image acquisition and analysis routines. The system captures gray scale images with the variable retarders at four known settings. The resulting gray scale images are run through an algorithm that extracts quantitative values of optical retardation along with the slow axis direction (azimuthal angle) for each of the pixels locations in the images. The results are represented as a quantitative gray scale image map of optical retardation, azimuthal angle, or both. The results can be extracted or represented using common methods used in image analysis. A representative output example is shown in FIG. 3 for optical retardation measurements. Both the orientation and the magnitude are measured.

Grating Power Measurements

Reflected power is determined by measurement of a finished EPIC® microplate using a Corning EPIC®, high throughput scanning (HTS) system reader. The read can be a single read down the center of the sensor (100 microns wide) or a complete high resolution plate map at 12 microns in the scanning axis (long axis of part—4.7 inch dimension) and 100 microns in the perpendicular axis. The reflected power from an EPIC® sensor is a function of the sensor reflectivity (birefringence and grating shape) and the angle between the sensor and the collimator detector. For this reason, a test bed system was designed that automatically aligns a collimator with each well individually. The result is a pure measurement of reflectivity that is not confounded by collimator misalignment. When all 384 wells are measured, the results are normalized and a reflectivity heat map is created.

Stampers

Stampers are 300 microns thick and can be made of high-sulfur nickel. Stampers were from Temicon Gmbh (Dortmund, Germany).

Tooling Materials

The injection mold was fabricated with a P20 mold base and consists of 420 stainless steel cavity and core inserts. The cavity panel has an optically lapped finish and a diamond-like coating (DLC) to maintain an optimal molding surface. This DLC coated panel holds, supports, and locates the stamper in the mold. Melt delivery is achieved with a cold sprue bushing through the cavity panel to a fan style runner that is inserted into the core ring. The runner conveys molten material from a sprue to a gate. Including the runner detail in the mold enabled the development of an optimal runner and gate design for this application. FIG. 4 shows a CAD rendered image of the core ring having the steel runner insert, specifically, showing how mold tooling (410) can be inserted into or interchanged in the mold (400) for investigating various runner (420) designs.

Process Details

The inserts can be injection molded using a 110-Ton horizontal press. Other than the inventive holding and packing parameters explained, the plastication and injection settings were run in the range recommended by the Topas 5013-L10 specification. Some typical settings included molding with a melt temperature between 550 and 570° F., injecting at a fill time of 0.1 to 1.0 seconds, cooling time of 35 to 45 seconds, and a mold temperature of 557 to 560° F.

Modeling Details

Numerical modeling was used to improve understanding of the product attributes of the injection molded (IM) substrate made by an injection molding process. This was accomplished with commercial AutoDesk Moldflow software. The resin properties were included in the software.

### Results and Discussion

Microplate Requirements

All EPIC® microplate readers call for a minimum power threshold to guarantee noise performance. For instance, the EPIC® reader HTS system calls for 1500 counts of power to register a data point; otherwise the data is ignored and no data from the individual well is possible. Low power or ‘dark’ wells are unacceptable to customers. Once an EPIC® reader is aligned and calibrated, the primary source of power variability is the microplate. Power variation due to the microplate or sensor substrate can be attributable to, for example: angular misalignment between the collimator and sensor plane; sensor malformation/geometry variability; and birefringence or optical retardation in the substrate.

Power loss due to microplate flatness variation results from angular misalignment between the reflected beam and the collimator. The misalignment can be improved by minimization of microplate flatness variation and substrate parallelism variation.

A second cause or source of power reduction is sensor malformation during the fabrication step. Modeling has demonstrated lower power results when the sensor geometry is not uniform over the beam spot size (e.g., about 80 microns). Sensor malformation is primarily a result of systematic error or manufacturing variability.

Still another source of power reduction is birefringence within the sensor substrate. The EPIC® reader systems can adapted to filter reflected light based on polarity using a polarizer and quarter wave-plate in the optical path. This can minimize back-reflections from surfaces of the substrate. The system is also designed to minimize power reflected in the transverse electric (T_{E})-reverse mode as the measurement is based on wavelength changes of the transverse magnetic (T_{M})-mode. If the birefringence is high enough and oriented in an appropriate direction, the reflected beam polarization can change that leads to a combination of broadening of the T_{M} peak, reduction of the T_{M} peak, and increase in the background or other modes.

The EPIC® high throughput system (HTS) can accommodate substantial variation of power within the power budget. Five dB of the total 8.2 dB is budgeted for instrument channel to channel variation over the 16 channels. The remaining power is budgeted for the microplate variability resulting from angular alignment, sensor malformation, and birefringence. To separate the well understood effect of angular power loss from the remaining causes, a reflectivity measurement is used. The reflectivity is defined as the maximum power that is reflected from the sensor with no loss from mis-alignment of the collimator and reflected beam. The reflectivity variability is due to sensor geometry variability and birefringence effects only. This allows a more direct measurement of the effects of birefringence and grating height on power.

The maximum allowable variability of the microplate flatness (angular alignment) and reflectivity both consume power from the same microplate power budget; therefore, the specifications are interdependent. In commercial biosensor product designs the flatness specification can be set to 2.95 mRad max flatness on a per well basis. This allows up to 30% variation in the sensor reflectivity to guarantee that a microplate can be read on all enabled systems in the field. Based on inventive process capability all wells should register a value within 70% of the maximum reflectivity measured on the substrate.

Birefringence Effect Characterization

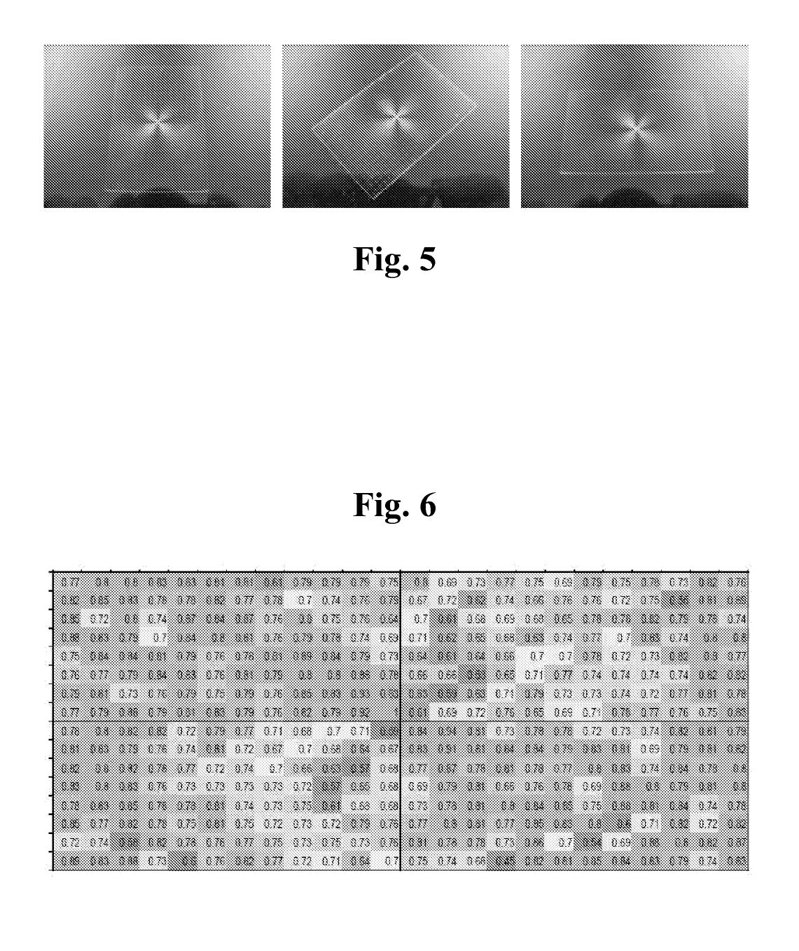

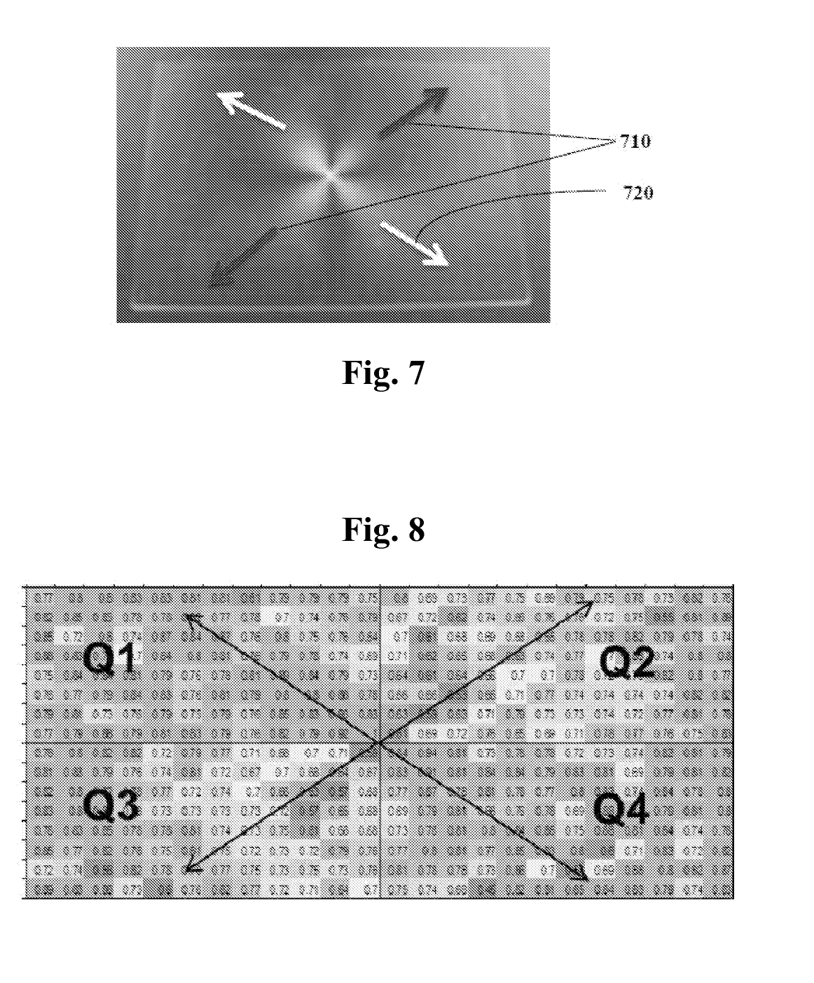

To understand and isolate the effect of birefringence, a model substrate molding system was used. The model was a first generation plastic substrate process that used a center-gated injection mold. This gating scheme and mold design is significantly different from the side gate style discussed later, but serves as a tool to isolate the effects of birefringence on the reflectivity parameter. In this center-gated injection mold system, the plastic melt is injected in the center of the part resulting in a distinct radial melt flow. FIG. 5 shows a birefringence pattern of a comparative center gate substrate rotated through 90 degrees on a polarizer table. The polarization is uniform radially and the resulting birefringence pattern is independent of the orientation of the piece. This biaxial flow resulted in a distinct and uniform radial birefringence pattern as shown in FIG. 5 as the sample is rotated through 90° on a polarimeter table. The optical retardation and grating geometry (grating height) were also measured at various wells around the gated region. As mentioned above, example output from the optical retardation measurements is shown in FIG. 3. The results are summarized in Table 1. Upon measurement of the reflectivity, a ‘clover-leaf’ pattern was identified. FIG. 6 shows a normalized reflectivity map of the comparative center-gate substrate illustrating the reflectivity depression in opposing quadrants. The reflectivity specification is 70% of the maximum measured reflectivity on the substrate. The reflectivity is normalized to its maximum value and color-coded (shown in gray scale) according to specification. Reflectivity values less than 0.7 (less than 70%) do not pass the specification, and reflectivity values greater than 0.7 (greater than 70%) pass the specification. The grating geometry of the sensors in all four quadrants was found to be comparable suggesting the uniformly radial birefringence does not result in a uniform effect on the reflectivity. This concept is illustrated for the comparative substrate (700) in FIG. 7. FIG. 7 shows a polarizer image of a comparative center-gated substrate (700) having added arrows to indicate the melt flow direction. This substrate (700) design exhibits a radial flow pattern resulting in a distinct birefringence pattern due to biaxial flow. The dark arrows indicated the orientation of the birefringence that depresses the reflectivity of the RWG sensors. This type of configuration was used to demonstrate the effect of birefringence. The comparative sensor has significant birefringence (center clover pattern) where the dark arrows (710) (artificially added for illustration) indicate a depression and the white arrows (720) (artificially added for illustration) indicate an enhancement in power. Indeed, only the upper right and lower left quadrants were power depressed. This observation indicates the EPIC® power measurement is sensitive to the birefringent orientation of the sensor. Based on the reduced impact further from the gate, the magnitude of the birefringence is also likely a contributor. Additionally, if the part is rotated by 90 degrees and the reflectivity is re-measured, it is found that the same wells are still depressed. In other words, the pattern rotates with the substrate. These observations confirm that the orientation of the birefringence pattern with respect to the sensor is important, not the EPIC® instrument.

TABLE 1
Characterization data for the center gate part
on four corner wells in each quadrant near the gate.

| | | Reflectivity - | | | |
|---|---|---|---|---|---|
| | | rotated | | Birefringence/Optical | Birefringence/Optical |
| | | substrate 90 | Grating | retardation | retardation |
| | Reflectivity | degrees | height | orientation (slow | magnitude |
| Well | (normalized) | (normalized) | (nanometers) | axis) | (nm/cm) |
| G11 | 0.93 | 0.92 | 48.02 | 135 | 200 |
| G13 | 0.59 | 0.61 | 49.41 | 45 | 200 |
| J11 | 0.64 | 0.62 | 48.50 | 45 | 200 |
| J13 | 0.91 | 0.91 | 48.08 | 135 | 270 |

Areas of maximum birefringence magnitude are found near the gate (rows A and B). In contrast, areas farthest from the gate result in significantly lower birefringence (rows O and P). For all wells measured, the maximum birefringence was 270 nm/cm and all wells were within 20 degrees of being orthogonal or parallel of the sensors. Representative birefringence and orientation data for injected molded substrates of the disclosed process are listed in Table 2.

TABLE 2
Representative birefringence and orientation
data for injected molded substrates.

| | Birefringence | Orientation |
|---|---|---|
| Well | (nm/cm) | (degrees) |
| A1 | 270 | 110 |
| A2 | 270 | 102 |
| A3 | 270 | 100 |
| A14 | 270 | 90 |
| B14 | 270 | 90 |
| O15 | 45 | 90 |
| P14 | 10 | 110 |
| P15 | 5 | 110 |

The effect of the birefringence was further characterized by measuring the optical retardation diagonally in each quadrant as illustrated in FIG. 8. FIG. 8 shows quadrant identification for a comparative center-gate substrate. The comparison of the birefringence versus reflectivity is performed along the wells in the path of the arrows. The arrows also indicate the orientation of the slow ray axis of the birefringence. The slow ray is the ray that has the highest effective refractive index.

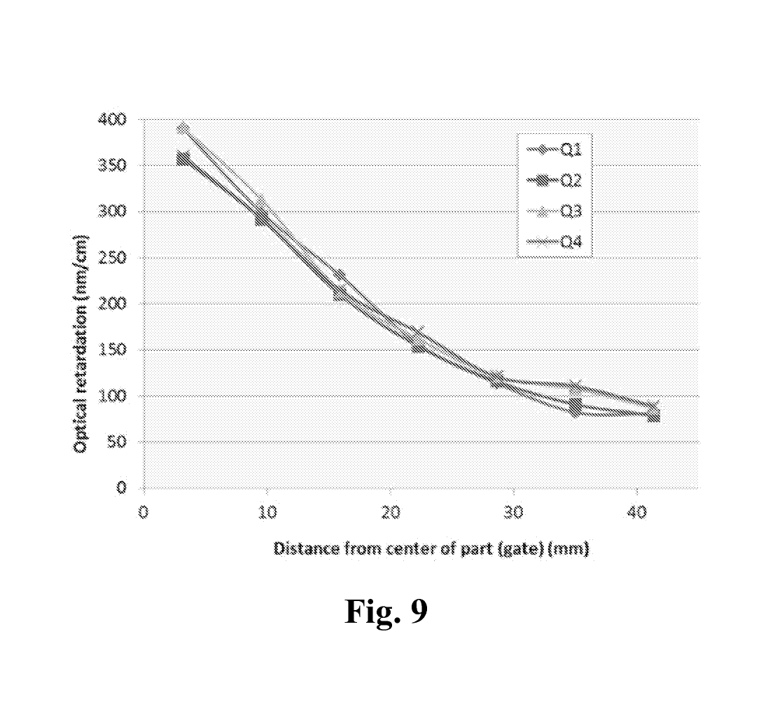

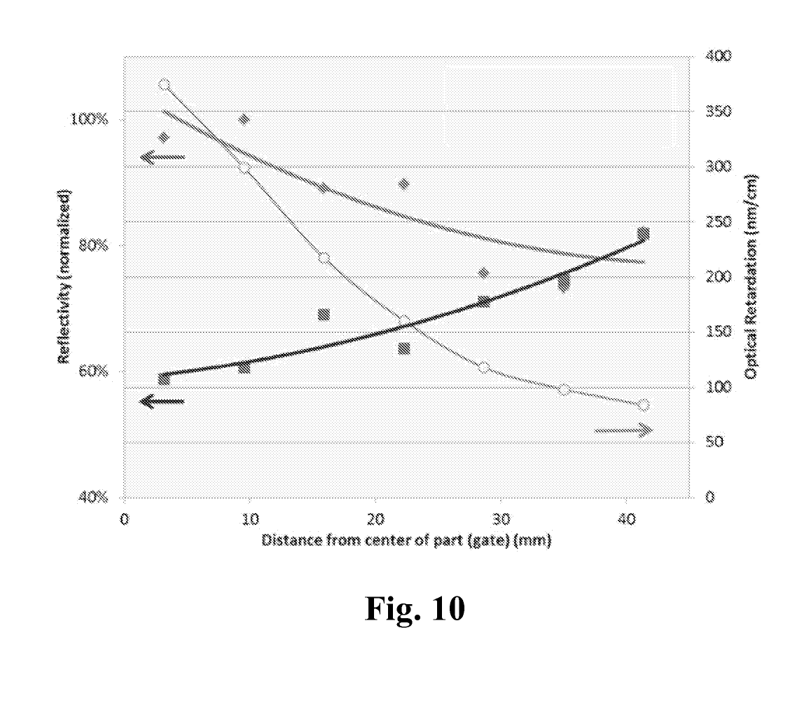

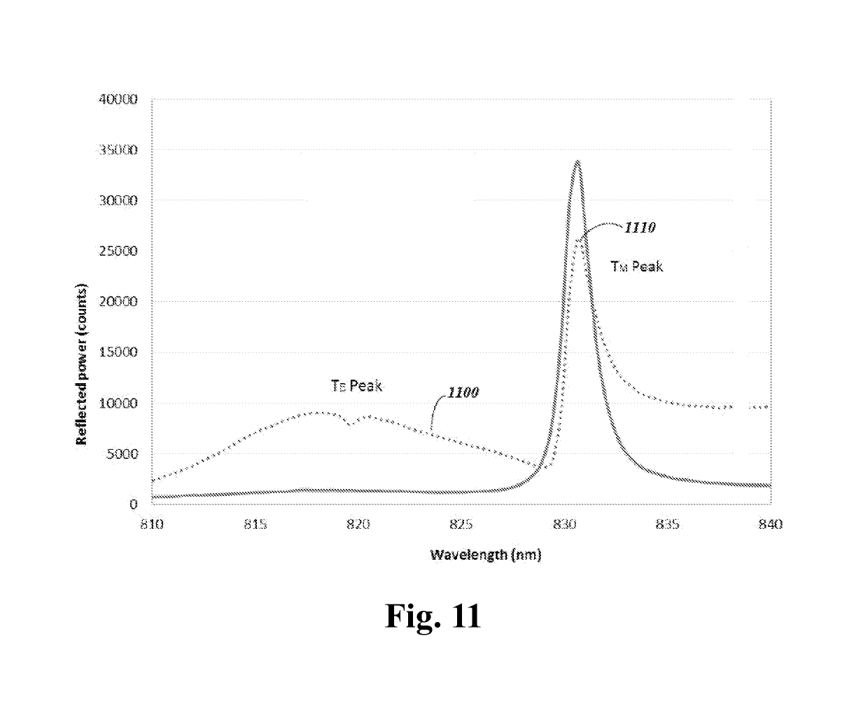

FIG. 9 shows a measurement of optical retardation (birefringence) as a function of radial distance from the center of the part (gate) along the paths described in FIG. 8. This diagonal was adopted to ensure uniform birefringence orientation. The results charted in FIG. 9 indicate a uniform decay in the optical retardation from the center of the part to outer edge typical for this type of part. The symmetry is radial with minimal differences among the four quadrants. The reflectivity of the same wells was also measured. The reflectivity and retardation of two quadrants are compared in FIG. 10. This relationship once again demonstrates the effect of the optical retardation orientation. In quadrant one, the reflectivity is enhanced near the center, whereas the opposite occurs with quadrant two. Indeed, the reflectivity near the center of quadrant two is nearly 40% lower than the enhanced reflectivity. This large difference in reflectivity results in consuming a significant portion of the power budget for a reader. For this reason, it is highly desirable to minimize the impact of the substrate birefringence magnitude and control the orientation. To obtain this result, the retardation should be minimized preferably below about 120 nm/cm or the birefringence should be orientated parallel or perpendicular to the sensors (or part edge). In addition, the effect of birefringence can also be observed in the actual reflected spectra. This is illustrated in FIG. 11 where the high birefringence region results in a lower T_{E} peak and a higher T_{M} peak.

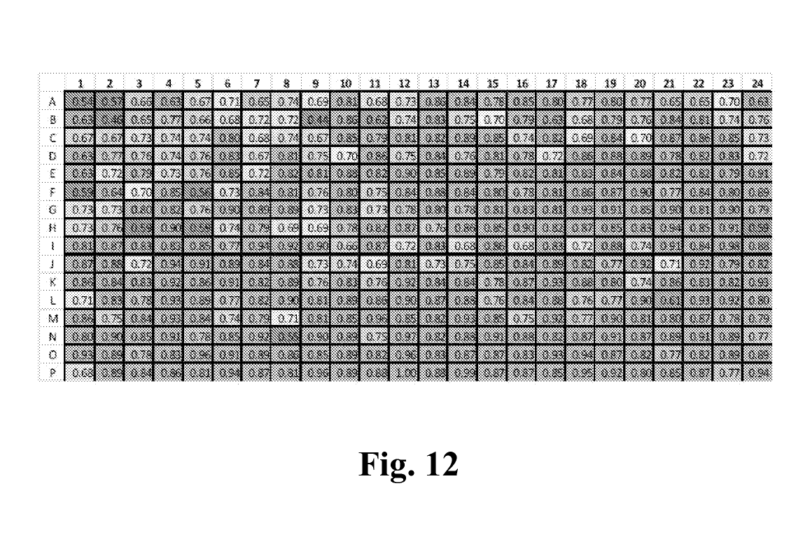

With knowledge of the effect of birefringence on the RWG interrogation, it was possible to rapidly troubleshoot the cause of lower power on the production side-gated mold. A region of low power was systematically observed in the A1 corner (top left) as shown in FIG. 12. However, a symmetric region of low power was not observed in the A24 corner (top right). This observation can be accounted for by non-parallel melt flow in the A1 and A24 region due to the gate transition. The melt flow in the A1 corner is comparable to the flow direction of quadrant 3 (Q3) in FIG. 8, whereas the melt flow in the A24 corner is comparable to the flow in quadrant 4 (Q4) of FIG. 8. As noted previously, the reflectivity is only depressed in Q3 due to the birefringence orientation.

Birefringence Simulation of Varying Runner Designs

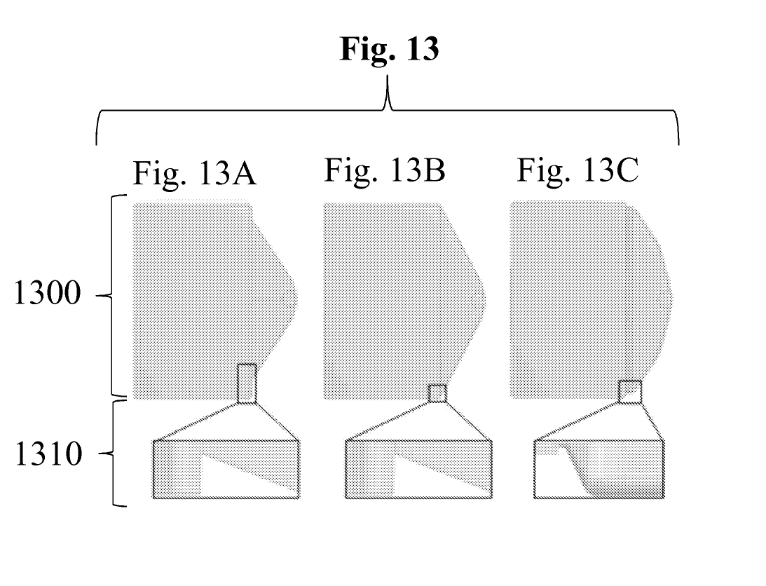

The stress optical law suggests that birefringence is directly proportional to the absolute value of the difference of the in-plane principle stress. To study the birefringence of the substrate, the stress state of the part was analyzed using numerical models. FIGS. 13A to 13C show, respectively, a partial fan gate (13A; left), full fan gate (13B; center), and the inventive deep dish gate (13C; right), of three gate configurations that were modeled. The main differences between these gates are the extent of the width of the gate, and their cross-sectional profile. The partial fan (13A) has a wedge shaped profile and does not extend up the entire width of the substrate. The full fan (13B) has a similar profile to the partial fan but it extends up to the entire width of the substrate. The deep dish (13C) also extends up to the entire edge of the substrate, but as seen from FIGS. 13A to 13C, the deep dish cross-section differs considerably from either the partial fan or the full fan configurations.

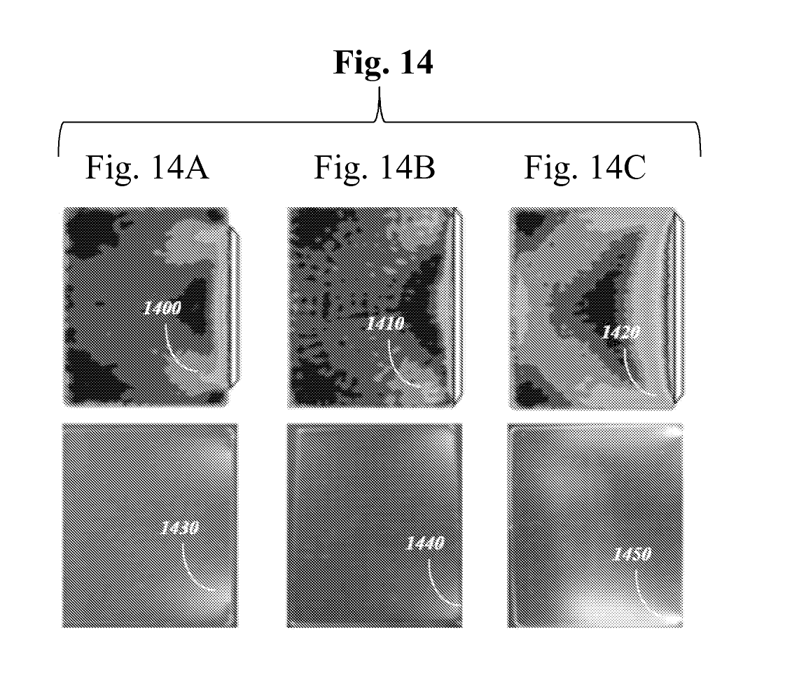

FIGS. 14A to 14C show, respectively, stress states predicted by modeling (top images) and the experimentally observed birefringence (bottom images). It can be seen that the regions of high stresses (from modeling)(1400, 1410, 1420) and the plumes of high birefringence (from experiments) (1430, 1440, 1450) are in good agreement. It can also be noted that, as one moves from images on the left to images on the right, i.e., from partial fan to full fan to deep dish, plumes of high birefringence shift towards the edges of the substrates.

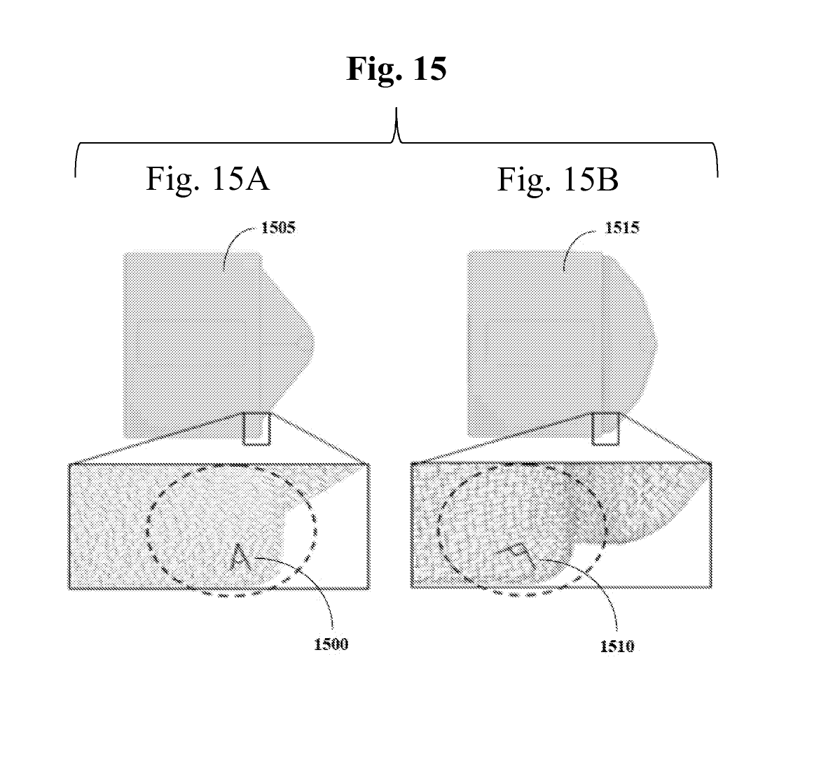

To understand the directional effects of polymer orientation on birefringence, molecular orientation of the polymers in the mold parts were analyzed. FIGS. 15A and 15B show insets of overlays of the molecular orientation at the skin and core for the, respective, partial fan gate (15A; left) and deep dish gate (15B; right). Simulated lines represent the orientation of the molecules at the skin and at the core. In the region of the substrate which is away from the partial fan gate, the angle of orientation of molecules between the skin and the core is about 90° (15B; 1510 and 1515). In contrast, in the region where partial fan gate connects to the substrate the angle of orientation of molecules between the skin and the core varies between about 30° to about 90° (15A; 1500 and 1505). These regions also show high birefringence and low reflectivity. For deep dish, in the region of the part near the gate, the angle of orientation of molecules between the skin and the core is almost 90° and these regions show low birefringence and high reflectivity. Hence, when the angle between the molecules at the skin and the core is around 90° the substrate shows low birefringence; and when the angle varies between about 30° to about 90° high birefringence is observed. Thus, it is significant to have a gate which generates uniform molecular orientation such that the angle between the molecules at the skin and the core is around 90°.

As learned from residual stresses and orientation of molecules in the substrate, the most significant contributors for high birefringence (hence low reflectivity) are: the residual stresses that are developed near the gate, and the orientation of molecules in the same region. Both of these factors are highly dependent on the gate design, i.e., the type of gate that is being used and where the gate connects with the substrate. The deep dish generates a uniform molecular orientation at the core and the skin. However, since the existing gate does not extend up to the entire length of the substrate, high stress regions can cause birefringence in the regions where nanostructures features (see for example, as disclosed in the aforementioned cross-referenced application) can be located. Hence, a deep dish gate, which extends up to the entire length of the substrate, was targeted as a potential solution.

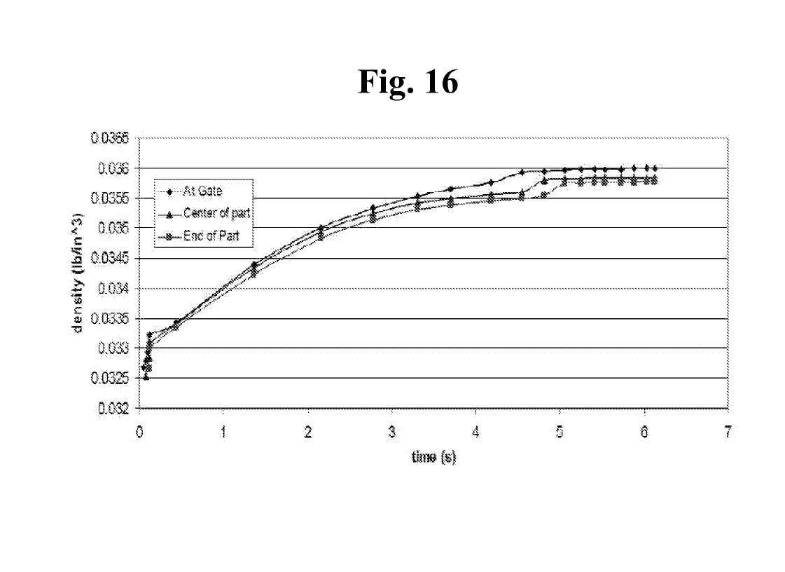

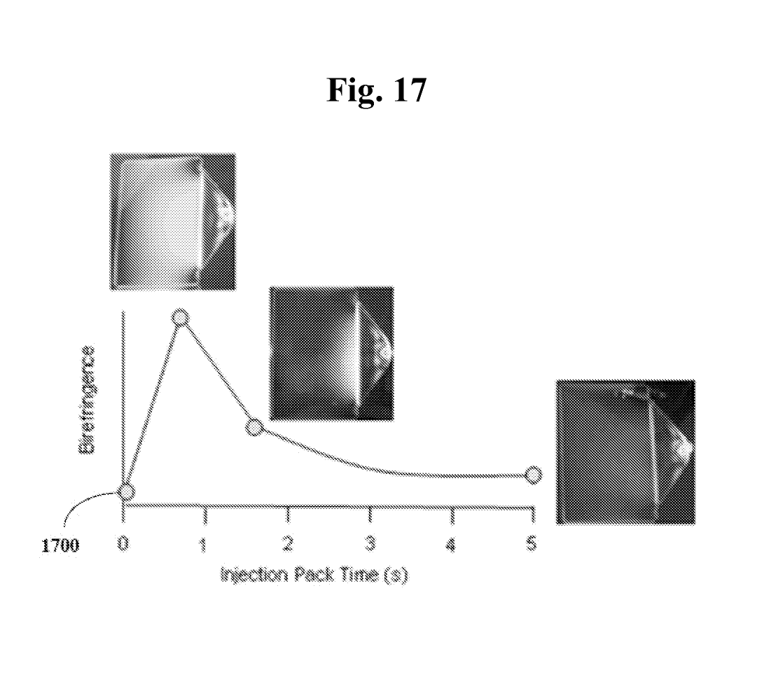

Effects of process parameter on stress/birefringence of the substrate were also studied using numerical models. It was observed that as hold time is increased, molten plastic starts to solidify and after about 5 seconds, the gate freezes completely, and the density of the substrate becomes constant as shown in FIG. 16, which shows density change in the injected part with respect to time. This prevents back flow of plastic into the gate once the hold pressure has been removed. Hence, a pack time, that is, a hold time, of about 4 to about 5 seconds was targeted to help lower the birefringence. This target was validated with timed experiments. FIG. 17 shows the observed decrease in birefringence with increasing hold time. A zero hold time exhibits minimal birefringence (1700).

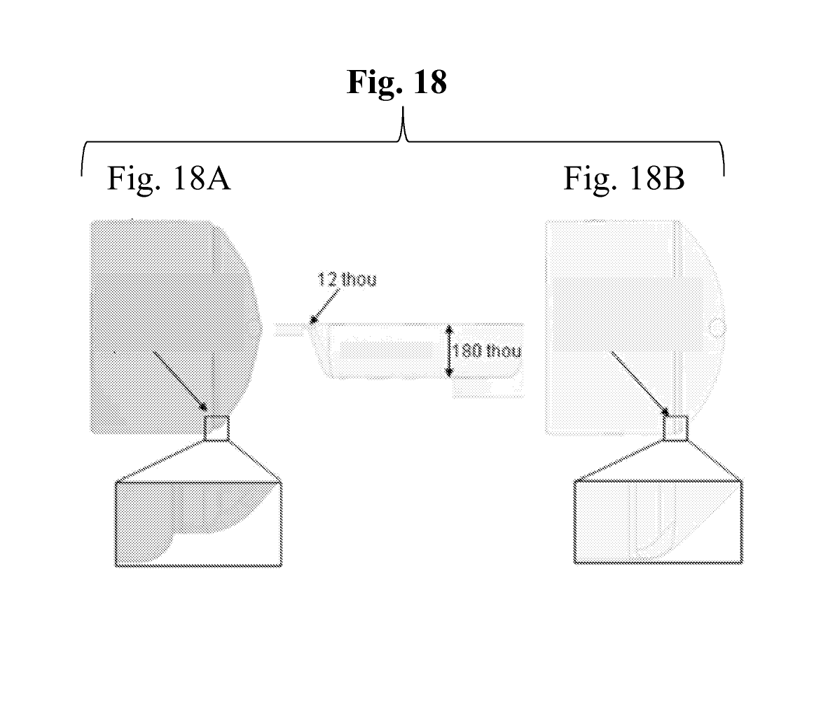

All the knowledge obtained from analyzing the stress state in the substrate, effects of molecular orientation, and pack time on birefringence, were used to develop the fullest deep dish. FIG. 18 introduces the fullest deep dish, which was developed such that the gate extends up to the entire length of the substrate. By doing this, the residual stresses can be pushed towards the outer edge of the substrate and away from the nanostructures. FIGS. 18A and 18B show top views of a deep dish gate (18A; left) and a fullest deep dish gate (18B; right). The side view of the deep dish gate region (middle) of the fullest deep dish gate has dimensions of 180 thousandths before the gate and a 12 thousandths neck.

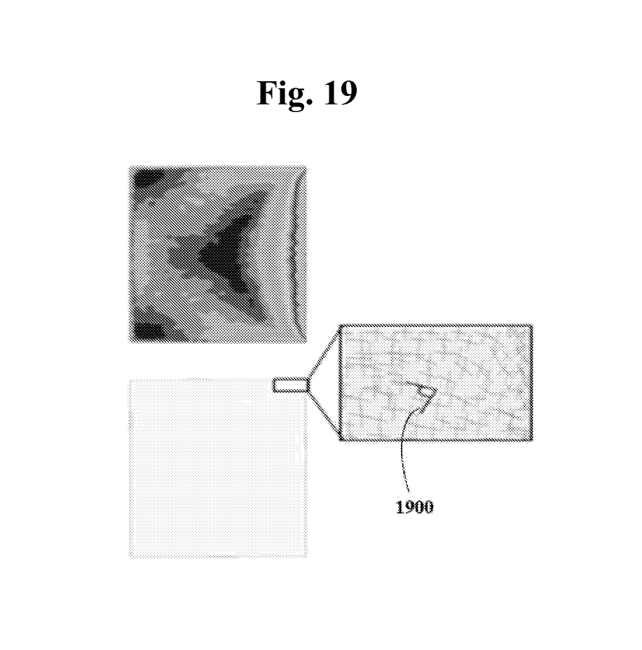

FIG. 19 shows the experimental and modeling results for fullest deep dish. Experimental results include reflectivity and birefringence maps of the substrate. Modeling results include the stress state and molecular orientation of the substrate. The angle of orientation of molecules between the skin and the core is about 90° (1900) as indicated by the inset (middle right).

Ideal Birefringence Part

Both experimental results and modeling have indicated that to minimize the interaction and power degradation caused by birefringence during interrogation of a RWG sensor, the ideal substrate would contain birefringence values below about 120 nm/cm in the sensor region. To minimize the effects of high birefringence for measurements on an EPIC® system, it is desirable that birefringence be oriented either parallel or perpendicular to the sensor features as this tends to result in the least impact to reflectivity. Orientation outside of these ranges can result in increased power variation during interrogation. For example, orientation at 45° relative to the grating feature can result in up to 30% loss of power.

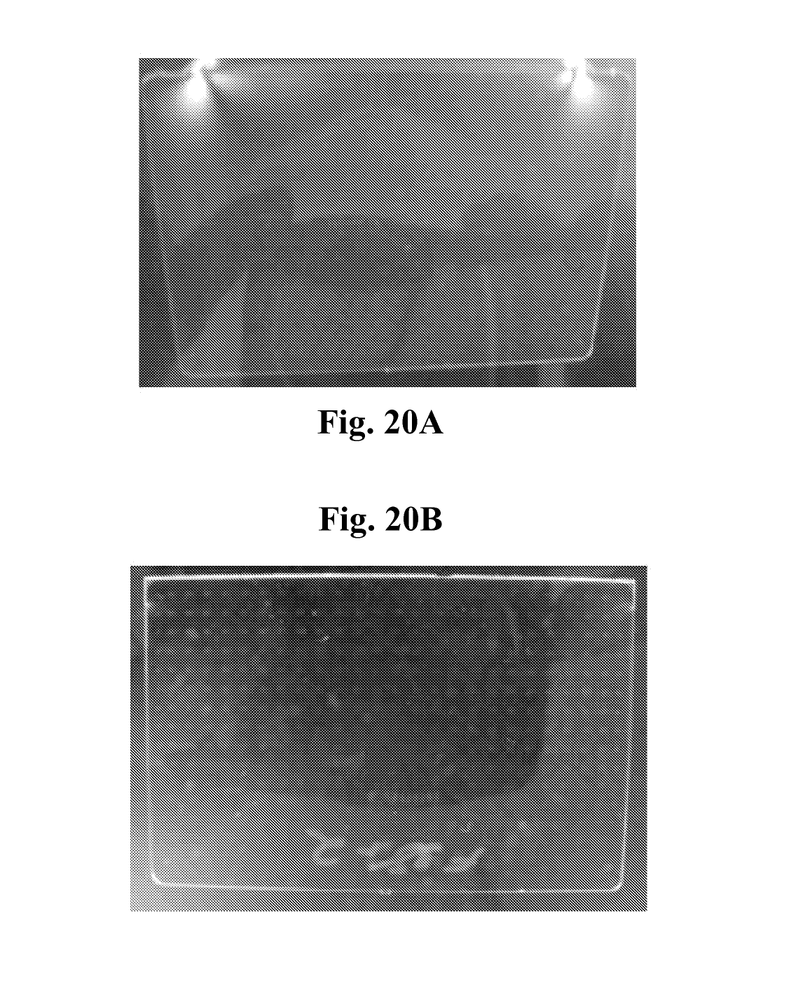

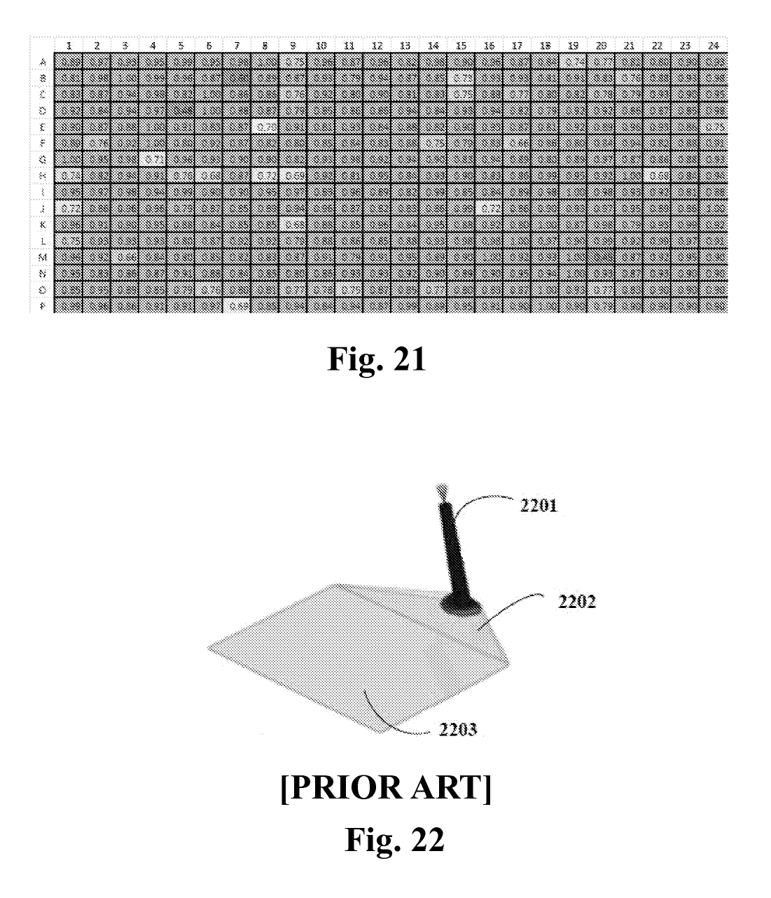

A part having minimal birefringence was fabricated using a side-gated molding design. The design was aided by modeling the effect of birefringence on the process parameters and runner design. Measured birefringence retardation of the produced part is less than about 220 nm/cm over the entire part. The impact of the orientation of the region with higher retardation is minimized by keeping the orientation angle to less than 20°. The part was produced by injection molding using a combination of unconventional tooling and unconventional process conditions. Both the tooling and the process conditions were identified, verified by melt modeling, or both. A polarimeter image of the inventive molded substrate is shown in FIG. 20A and its associated reflectivity map is shown in FIG. 21. FIGS. 20A and 20B show optical polarimeter images of a comparative substrate (20A) and the inventive low birefringent substrate (20B) produced using injection molding with the disclosed tooling and process. No significant birefringence was apparent in the inventive low birefringent substrate (20B). Significant birefringence was evident at top right and top left in the comparative substrate (20A). The dark regions in both FIGS. 20A and 20B are imaging artifacts (i.e., shadows of photographer's hand and camera). FIG. 21 shows the normalized reflectivity map of the low birefringent substrate. Singular outliers are a result of measurement system error and do not fail functional testing. The tooling and process conditions for fabricating such a part is provided as one example method of fabrication.

Example Methods of Production

The following example describes an injection molding method for making a substrate bearing sensors using specific mold tooling designs and unconventional process conditions.

Conventional Design

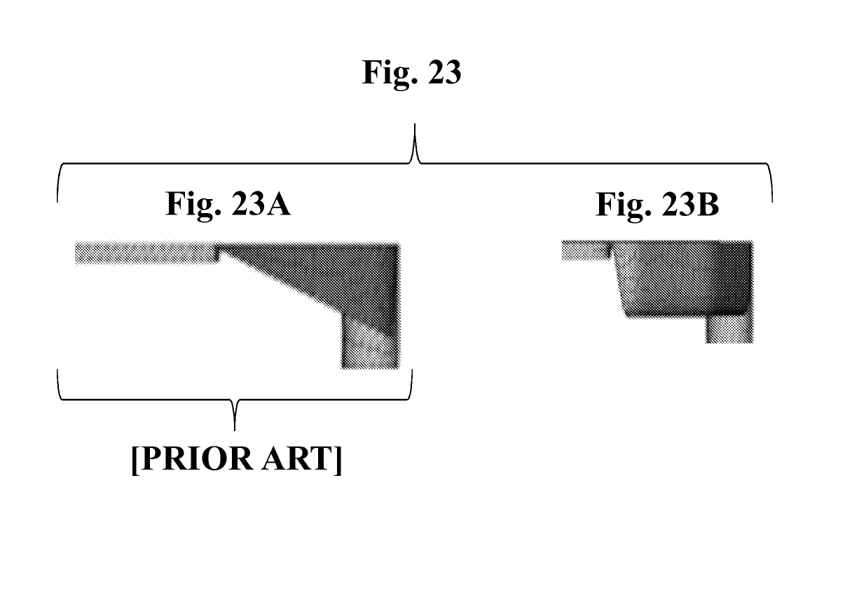

FIGS. 23A and 23B show, respectively, a runner cross section comparing the prior art sloped fan style (23A; left) and the inventive ‘melt reservoir’ style (23B; right). A typical fan style runner design consists of a sloped transition from the diametric sprue to the gate going into the full part edge as shown in FIG. 23A (PRIOR ART). The schematic of a prior art conventional runner of FIG. 22 shows a sprue (2201), gate (2202), and insert (2203) regions, respectively. The transition dimensions are also designed to have a uniform cross sectional area throughout the flow path leading up to a gate. The gate thickness for optical parts is specified to be 60% or greater than the part thickness to achieve low shear stress during filling. The conventional design elements yield relatively uniform melt flow, while allowing for reasonable cooling time. Additionally, subtle flow effects can result from localized pressure drops in regions where the geometry tapers down quickly. The subtle flow effects can generate unacceptable birefringence levels in the part for this application.

Mold Design

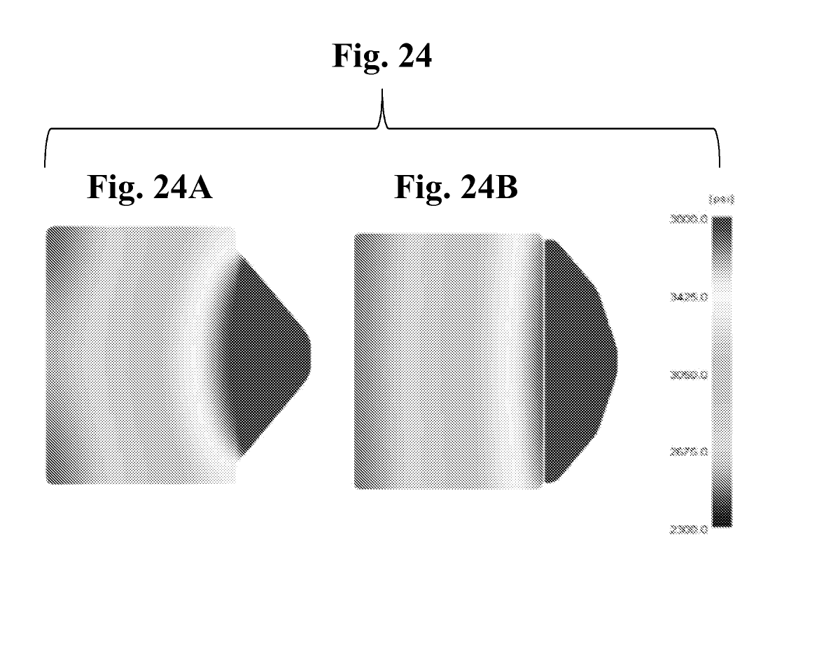

Several unconventional design concepts were included in the injection mold used to produce low birefringent substrates. The gate thickness and the gate land were found to be important factors for improving the flow uniformity. A gate thickness of 0.012″, or about 30% of the part thickness, is half of the conventional design of 60%. Parts without the land of 0.030″ resulted in molding defects near the gate causing low power in some wells in the ‘A’-row. These fan designs are shown in FIG. 13. Secondly, a cavity in the runner, just prior to the gate, was found to improve flow uniformity within the substrate cavity. The combination of these features results in a uniform pressure and flow profile across the substrate cavity. Indeed, the pressure profile of several designs were modeled using modeling software and are shown in FIGS. 24A and 24B. FIGS. 24A and 24B show, respectively, modeled pressure profile differences between the conventional sloped fan runner (24A; left) and the melt reservoir runner (24B; right). The melt reservoir results in a more uniform pressure and flow profile. The features can act as throttle on the melt fill and prevent the melt from entering the insert cavity through the center of the gate before the edges. The reduction in biaxial flow in the insert cavity significantly reduces the presence of birefringence in the part.

Exceptional Process Conditions

Modeling of the molding process also revealed unconventional process conditions that can minimize birefringence. Specifically, hold time is commonly used to balance part stress against part detail, warping, and cycle time. Modeling of various hold conditions revealed that a long hold time, for example, greater than about 2 seconds, more preferably 3 seconds, even more preferably 4 seconds, and still more preferably 5 seconds, can significantly reduce the birefringence in the part. Monitoring of the melt density was effective in predicting a superior hold time to minimize back flow until the 0.012″ thick gate froze as shown in FIG. 16.

Both the magnitude and orientation of birefringence have an effect on the reflectivity and the subsequent reflected power during interrogation of RWG sensors (such as in the EPIC® sensors). For this reason, a low birefringent substrate, defined as less than 120 nm/cm of optical retardation, an orientation preferably aligned parallel to or orthogonal (i.e., perpendicular) to the sensor, or a combination of both parallel or orthogonal, can be preferred for a RWG interrogation system such as the Corning EPIC® system. A combination of unconventional tooling designs and process conditions have been disclosed and used herein to demonstrate fabrication of such a low birefringent substrate. Modeling of the molding process also revealed unconventional process conditions that can minimize birefringence. Specifically, hold time can be used to balance part stress against part detail, warping, and cycle time. Modeling of various hold conditions revealed that a longer hold time significantly reduces the birefringence in the part.

The disclosure has been described with reference to various specific embodiments and techniques. However, it should be understood that many variations and modifications are possible while remaining within the scope of the disclosure.

1. A resonant waveguide grating article, comprising:
a polymeric substrate and the integral grating region;
wherein the article has a low birefringence property of from about 5 to 270 nm/cm.

2. The article of claim 1, wherein the length and width dimensions of the substrate are about 4.7 by about 3 inches, the thickness of the substrate is from about 0.5 to about 1.5 millimeters having less than about 2% variation, and the grating height is about 0.05 to about 1 micrometer.

3. The article of claim 1, wherein the substrate and the integral grating region comprise an optically transparent engineering resin.

4. The article of claim 3, wherein the optically transparent engineering resin comprises a COC resin, a polystyrene resin, or a combination thereof.

5. The article of claim 1, wherein the optical axis orientation of the birefringence is substantially parallel or perpendicular to the lines of at least one of the grating regions.

6. The article of claim 1, wherein the article has power uniformity where the power of each of the sensors in the article is within about 30% of the maximum power of the sensor.

7. The article of claim 1, further comprising an integral well plate directly bonded to the article to provide a microplate.

8. The article of claim 7, wherein the microplate has optical alignment variation of less than 2 milliradians, flatness and parallelism variation such that the angle between the launch and reflected light beams is less than 2 milliradians for each of the sensors in the microplate.

9. The article of claim 7, wherein the microplate has from 1 to 1536 wells.

10. The article of claim 1, wherein the at least one integral grating region comprises a plurality of parallel grating lines.

11. A method of making the article of claim 1, comprising:
a single cavity injection molding to form the substrate having at least one grating feature on at least one surface of the substrate,
the mold being selected for the single cavity injection molding comprises a melt reservoir prior to a gate, the gate being about 30% of the width of the substrate mold cavity, the melt reservoir is situated in a runner leading to the gate, the melt reservoir enhances the parallelism of the injected resin flow, and the single cavity injection molding is accomplished at a high pack pressure of about 5,000 psi to about 10,000 psi, for from about 0.1 to 0.5 seconds, and then a long hold time of about 5 to about 10 seconds at a lower pressure at from about 2,000 psi to about 4,500 psi.

12. The method of claim 11, wherein the optical axis orientation of the birefringence is substantially parallel to the lines of at least one grating region.

13. The method of claim 11, wherein the single injection molding step to form a substrate having at least one grating region on at least one surface of the substrate is accomplished with a metal master containing the mirror image grating pattern on at least one half of the mold cavity.

14. The method of claim 11, further comprising an assembly step to join the article and a well plate to form a unitary microplate assembly containing at least one well.
